(19) United States
(12) Patent Application Publication
(10) Pub. No.: US 2026/0119537 A1
(43) Pub. Date: Apr. 30, 2026

(54) SYNTHETIC KNOWLEDGE INGESTION FOR ENHANCING LARGE LANGUAGE MODEL PERFORMANCE

(71) Applicant: Intuit Inc., Mountain View, CA (US)

(72) Inventors: Wendi CUI, Jersey City, NJ (US); Jiaxin ZHANG, Mountain View, CA (US); Yiran HUANG, San Diego, CA (US); Damien LOPEZ, San Diego, CA (US)

(21) Appl. No.: 18/930,938

(22) Filed: Oct. 29, 2024

(51) Int. Cl. G06F 16/332; G06F 16/33

(52) U.S. Cl. CPC G06F 16/3329; G06F 16/3344

(57) ABSTRACT

Certain aspects of the disclosure provide a method for augmenting an information repository for information retrieval by a large language model. The method may include obtaining an information item from an information repository; allocating portions of the information item into a plurality of contextual units; generating, by a first language model, a plurality of content units based on the plurality of contextual units; constructing an augmented dataset that includes one or more content units of the plurality of content units; receiving a query; inputting the query and the one or more content units of the plurality of content units into one or more language models; and obtaining, as output from the one or more language models, a response to the query based on the input query and the one or more content units of the plurality of content units.

### BACKGROUND

### Field

Aspects of the present disclosure relate to information retrieval and language models.

### Description of Related Art

Large language models have become increasingly prevalent in various applications, including question-answering systems, chatbots, and content generation tools. These large language models may be trained on large amounts of textual data and can generate human-like responses to a wide range of queries. However, the effectiveness of these models often depends on the quality and relevance of the information they can access during the response generation process.

Traditional approaches to information retrieval for language models typically involve either frequent retraining of the model with updated data or implementing separate knowledge bases that can be queried alongside the model. These methods present challenges in terms of computational resources, maintaining up-to-date information, and seamlessly integrating external knowledge with the model's inherent capabilities. As the volume and complexity of information continue to grow, there is an ongoing need for efficient and effective methods to enhance the performance of large language models in accessing and utilizing relevant information.

### SUMMARY

Certain aspects provide a method for augmenting an information repository for information retrieval by a large language model. In some aspects, the method may include: obtaining an information item from an information repository; allocating portions of the information item into a plurality of contextual units, wherein each contextual unit of the plurality of contextual units comprises a portion of the information item; generating, by a first language model, a plurality of content units based on the plurality of contextual units, wherein each content unit of the plurality of content units is associated with a contextual unit; constructing an augmented dataset that includes one or more content units of the plurality of content units; receiving a query; inputting the query and the one or more content units of the plurality of content units into one or more language models; and obtaining, as output from the one or more language models, a response to the query based on the input query and the one or more content units of the plurality of content units.

Some aspects provide a method for augmenting an information repository for information retrieval by a large language model. In some aspects, the method may include: receiving a query; obtaining an information item from an information repository based on the query; allocating portions of the information item into a plurality of contextual units, wherein each contextual unit of the plurality of contextual units comprises a portion of the information item; generating, by a first language model, a plurality of content units based on the plurality of contextual units, wherein each content unit of the plurality of content units is associated with a contextual unit; constructing an augmented dataset that includes one or more content units of the plurality of content units; inputting the query and the one or more content units of the plurality of content units into one or more language models; and obtaining, as output from the one or more language models, a response to the query based on the input query and the one or more content units of the plurality of content units.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a system for augmenting an information repository to enhance large language model performance, in accordance with aspects of the present disclosure.

FIG. 2 illustrates an example process for allocating contextual units from an information item, in accordance with aspects of the present disclosure.

FIG. 3 illustrates an example process for generating content units from contextual units using a language model, in accordance with aspects of the present disclosure.

FIG. 4 depicts various configurations for assembling and augmenting datasets derived from synthetic knowledge ingestion processes, in accordance with aspects of the present disclosure.

FIG. 5 depicts additional details of an augmented information retrieval engine utilizing synthetic knowledge ingestion techniques, in accordance with aspects of the present disclosure.

FIG. 6 depicts a system for augmenting an information repository to enhance large language model performance in a real-time, query-driven manner, in accordance with aspects of the present disclosure.

FIG. 7 depicts a method for augmenting an information repository, in accordance with aspects of the present disclosure.

FIG. 8 depicts another method for augmenting an information repository, in accordance with aspects of the present disclosure.

FIG. 9 depicts an example processing system with which aspects of the present disclosure can be performed.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for augmenting an information repository to enhance large language model performance. Certain aspects address challenges of enhancing language model responses with up-to-date, contextually relevant information without requiring constant retraining of the language model.

Language models may struggle with providing accurate and contextually relevant responses, especially when dealing with specialized or rapidly changing information. Traditional methods of updating these models, such as frequent retraining, are resource-intensive and impractical for maintaining real-time relevance. Additionally, retrieving and effectively utilizing external information to augment model responses presents significant technical challenges.

Aspects of the present disclosure address these technical challenges by implementing a system that dynamically processes information items from external information into contextual units, generates augmented content based on the contextual units using a language model, and stores this augmented content in an augmented information repository. In some aspects, when a user query, such as a query that may be included in a prompt, is received by the system, the system can retrieve relevant augmented information and incorporate the retrieved information into a language model's response generation process. This approach may allow for real-time integration of external knowledge without modifying the underlying language model.

This technical solution offers several advantages. For example, aspects described here may enhance an accuracy and relevance of a language model response by incorporating up-to-date external information. Thus, the system's ability to process and augment information in real-time provides a system that can address knowledge domains that include changing information. Furthermore, a modular approach of separating information augmentation from the language model enables more efficient updating of knowledge without requiring frequent model retraining, thereby reducing computational resources needed for more accurate response generation and improving system responsiveness.

### Example System for Augmenting an Information Repository

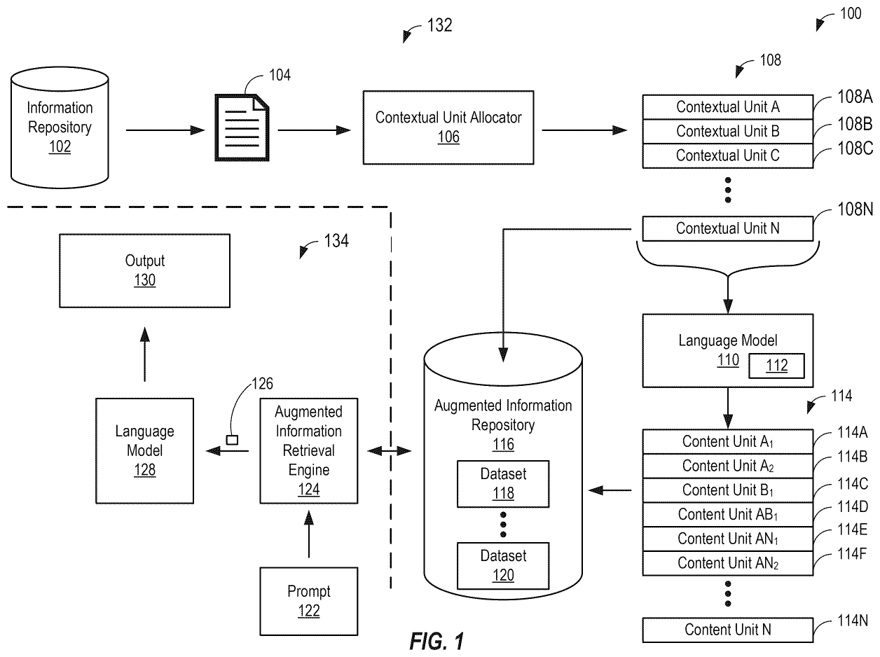

FIG. 1 depicts a system 100 for augmenting an information repository to enhance a language model's performance, in accordance with aspects of the present disclosure. The system 100 may be implemented using one or more computing devices, such as servers, desktop computers, laptop computers, or other suitable computing devices. In some examples, the system 100 may be distributed across multiple computing devices connected via a network, such as the internet or a local area network.

In some aspects, the system 100 may be configured to generate synthetic knowledge representations from raw knowledge sources, which may then be used to enhance the capabilities of language models in various domains, such as finance, biomedicine, and open-generation tasks. Additionally, as used herein, “raw,” used to further define an “knowledge sources,” may indicate that information obtained from the knowledge source is unprocessed, or more specifically that the information has not been organized and/or manipulated in any way. The information may simply be collected from one or more knowledge sources, such as devices, sensors, and/or databases, among others. In certain aspects, raw information may include domain-specific knowledge used to fine-tune an LLM. In some examples, the system 100 may implement a synthetic knowledge ingestion method that leverages fine-grained synthesis, interleaved generation, and/or assembly augmentation strategies to construct data representations from raw knowledge sources. Such strategies may be applied to various knowledge injection techniques, such as Retrieval Augmented Generation (RAG), to refine and enhance the knowledge capabilities of large language models.

In some examples, the system 100 may include an information repository 102, such as a database or storage system that includes a collection of information items 104 and associated data. An information item 104 may refer to a piece of content or data that contains information relevant to a particular topic or subject. For example, an information item 104 may be a document, article, webpage, or other form of structured or unstructured data. Other examples of information items 104 may include, but are not limited to: textual documents, such as articles, research papers, or reports; structured data, such as databases or spreadsheets; web pages or web content; social media posts and/or social media comments; product descriptions and/or technical specifications; legal documents; educational materials and/or course content; news articles; press releases; customer reviews and/or feedback; image data; audio data; and/or video data. In some aspects, the information repository 102 may be implemented using one or more storage devices, such as hard disk drives, solid-state drives, or cloud-based storage systems. The information repository 102 may be regularly updated with new information items and may support version control to track changes over time.

In some aspects, an information item 104 may be retrieved form the information repository 102 for processing by the system 100. The system 100 may process multiple information items 104 sequentially or in parallel, depending on the configuration and available resources. In some aspects, the information item 104 may be selected from the information repository 102 based on various criteria, such as relevance to a specific topic, recency, or importance. In some aspects, the system 100 may implement one or more selection algorithms to prioritize or select information items 104 for processing based on predefined rules or machine learning techniques. In some aspects, one or more information items 104 residing within the information repository 102 may be periodically augmented according to a timed event or other trigger. For example, news articles in the information repository may be automatically augmented daily to include latest developments and related contextual information. This ensures that the information repository 102 that may incorporate a knowledge base remains current and relevant for user queries about recent events.

In some aspects, the system 100 may include a contextual unit allocator 106 configured to process the information item 104 and divide the information item 104 into or otherwise extract smaller units of information, referred to as contextual units 108. In some aspects, a contextual unit (e.g., contextual unit A 108A) may refer to a smaller, more focused piece of information derived from the information item 104 as previously described. An example of a contextual unit might be a single sentence from a tax guide discussing a specific deduction rule. For instance, a contextual unit may be: “The annual contribution limit for a health savings account (HSA) in 2024 is $4,150 for individuals with self-only coverage and $8,300 for individuals with family coverage” which may have been obtained from the information item 104 having many pages, paragraphs, sentences, phrases, etc. In some aspects, the contextual units 108 may serve as the basis for generating synthetic knowledge representations and augmenting the information repository 102 based on the information item 104. For example, based on this contextual unit, the system 100 may generate a question-answer pair such as “Q: What is the HSA contribution limit for individuals with self-only coverage in 2024? A: The HSA contribution limit for individuals with self-only coverage in 2024 is $4,150.”

In some aspects, the contextual unit allocator 106 may employ various techniques to analyze the structure and content of the information item 104 and determine appropriate boundaries for contextual units 108. In some examples, content within the information item 104 may be allocated to different contextual units 108 based on the structure and content of the information item 104. For example, the contextual unit allocator 106 may use an n-gram approach to divide the information item 104 into the contextual units 108. An n-gram approach may involve creating sequences of n consecutive words or sentences from the information item 104. The value of n may be adjusted based on the desired granularity of the contextual units 108. For example, a 1-gram approach may create contextual units consisting of individual sentences, while a 2-gram approach may create units of two consecutive sentences. The contextual unit allocator 106 may utilize a 1-gram approach, a 2-gram approach, and/or another n-gram approach.

The contextual unit allocator 106 may employ other techniques to divide or extract information from the information item 104. Such techniques may include, but are not limited to: paragraph-based segmentation; topic-based segmentation using natural language processing techniques; semantic similarity-based clustering; named entity recognition for entity-centric segmentation; and/or temporal or chronological segmentation for time-based content.

In some aspects, the contextual unit allocator 106 may apply multiple segmentation techniques and combine the results of the segmentation techniques to create a diverse set of contextual units 108. In some aspects, multiple contextual units 108 may capture different aspects of the information item 104 and provide a richer set of contextual units for further processing. For example, when processing a long-form article about climate change, the system 100 might use paragraph-based segmentation to create initial contextual units, then apply named entity recognition to identify key concepts like “greenhouse gases” or “sea level rise.” Accordingly, the resulting contextual units 108 may capture both the structure and the semantic content of the information item 104.

In some aspects, the contextual units 108 may be stored in a structured format that maintains a relationship to the original information item 104 and facilitates further processing by other components of the system 100. For example, each contextual unit might be stored with the following attributes: a unique identifier for the contextual unit; the text content of the contextual unit; a reference to the information item 104; a position or location within the information item 104 (e.g., paragraph number, page number); topics or categories associated with the unit; and/or metadata such as creation date, last update time, and confidence score. A structured format allows the system 100 to maintain the context of each contextual unit 108, track its origin, and efficiently retrieve and process the information contained within the contextual units 108. In some aspects, metadata may be associated with each contextual unit 108 to provide additional context or aid in retrieval and analysis. For instance, the metadata may include information about the author of the original content, the date it was published, or tags indicating the relevance to specific domains or queries.

Example contextual units 108A-108N depict a subset of the contextual units 108 generated by the contextual unit allocator 106. In some aspects, these example contextual units 108 may represent different types or categories of information extracted from the information item 104. The number and diversity of example contextual units 108A-108N may vary depending on the complexity and content of the information item 104.

In some aspects, the system 100 may include a language model 110 configured to processes input data and generate output based on learned patterns and relationships in language. In some aspects, the language model 110 may be a large language model (LLM) trained on large amounts of text data. In other aspects, the language model 110 may be a smaller, task-specific model trained for particular applications. In some examples, the language model 110 may be implemented using various architectures, such as transformer-based models, recurrent neural networks (RNNs), or other suitable architectures. The language model 110 may be pre-trained on general language tasks and fine-tuned for specific domains or applications relevant to the information repository 102.

In some aspects, the language model 110 may be specifically used for generating synthetic content, such as questions, summaries, or paraphrases, based on the contextual units 108. Such synthetic content may enrich content of the information item 104 and aid in creating a more comprehensive augmented dataset. In some examples, the language model 110 may be different from a language model used to answer a final query (such as language model 128), as language model 110 may provide a distinct capability such as generating augmented data. In some examples, the language model 110 and the language model 128 may be the same model.

In some aspects, a prompt 112 may represent an input provided to the language model 110 to guide the generation of content units 114 based on the contextual units 108. In some aspects, content units 114 may represent augmented or transformed versions of the original contextual units 108, enriched with additional information, insights, or alternative representations. For example, a contextual unit 108B may include the following information from a tax guide: “The standard deduction for single filers in 2024 is $13,850.” A prompt 112 might instruct the language model 110 to “Generate a question-answer pair about the standard deduction information.” Based on this prompt, the language model 110 may generate a content unit 114A including: “Q: What is the standard deduction amount for single filers in the 2024 tax year? A: For the 2024 tax year, single filers can claim a standard deduction of $13,850.” This content unit 114 transforms the original statement from the contextual unit 108B into a question-answer format, which may be more easily used in retrieval tasks. That is, the content unit 114A maintains the core information from the contextual unit 108B but presents it in a different structure that may be more suitable for certain applications or queries. In some examples, the content units 114 may take various forms, such as: expanded explanations or elaborations of concepts; question-answer tuples related to the contextual units; paraphrased or simplified versions of complex information; cross-references or connections to related concepts; and/or generated examples or analogies to illustrate ideas.

In some aspects, the prompt 112 may be a text string that includes instructions, context, or examples to help the language model 110 produce relevant and accurate content. In some examples, the prompt 112 may be dynamically generated based on the characteristics of the contextual units 108 and the desired output format for the content units 114. The prompt 112 may include elements such as, but not limited to, task description or instructions; relevant background information; formatting guidelines; examples of desired output; and/or constraints or parameters for the generated content.

Example content units 114A-114N correspond to the contextual units 108A-108N, demonstrating how the language model 110 processes and augments the information of the information item 104. In some aspects, this correspondence may be one-to-one, where each content unit directly relates to a specific contextual unit. In other aspects, the correspondence may be more complex, such as one-to-many and/or many-to-many, with multiple content units derived from a single contextual unit or vice versa. In some examples, the correspondence between contextual units and content units may be as follows: content unit 114A may expand on the key definition or concept from contextual unit 108A, providing additional context or examples; content unit 114B may refer to a question-answer pair based on the factual statement in contextual unit 108B; content unit 114C may elaborate on the cause-and-effect relationship described in contextual unit 108C, offering additional insights or potential implications; content unit 114N may represent various other transformations or augmentations of the corresponding contextual units, such as summarizations, analogies, or alternative perspectives. In some aspects, a content unit 114A may include a question-context pair, where a generated question is associated with the original contextual information to facilitate more effective retrieval and understanding of the information. In some aspects, a content unit 114A may include a question-context-answer tuple, combining a generated question, the original context, and a synthesized answer to provide another representation of the information for enhanced knowledge retrieval and utilization by language models.

In some examples, the augmented information repository 116 may store the content units 114 obtained from the language model 110 in one or more datasets 118 and/or 120. In some aspects, the augmented information repository 116 may maintain a structure that preserves the relationships between original and augmented content, in order to facilitate an efficient retrieval and utilization of augmented content. In some examples, the augmented information repository 116 may implement indexing and search capabilities to enable quick access to relevant information. The augmented information repository 116 may also support version control and tracking of changes to monitor the evolution of augmented content over time.

In some aspects, the dataset 118 may refer to a collection of content units 114 within the augmented information repository 116. In some aspects, dataset 118 may contain various types of paired information derived from the content units 114 and their corresponding contextual units 108. In some examples, dataset 118 may include: question-context tuples, where questions are generated based on the contextual units and paired with relevant context; question-answer tuples, where both questions and answers are derived from the content units; and/or question-context-answer tuples, combining elements from both previous types.

In some examples, dataset 120 may refer to another collection of structured data within the augmented information repository 116. In some aspects, dataset 120 may contain similar types of paired information as dataset 118, but with differences in content, structure, or purpose. For example, the dataset 120 may differ from dataset 118 by focusing on different aspects or subsets of the augmented information, by using alternative formatting or structuring of the paired information, and/or by containing aggregated or summarized information from multiple content units.

In some examples, the prompt 122 represents an input query or instruction provided by a user to initiate the information retrieval process. In some aspects, prompt 122 may be a natural language question, a keyword search, or a more structured query designed to retrieve specific information from the augmented information repository 116. In some examples, prompt 122 may be processed and analyzed to extract concepts, intent, and context to improve an accuracy and relevance of the retrieved information. The system 100 may employ techniques, such as query expansion or reformulation, to enhance the effectiveness of the prompt 122 in retrieving pertinent information.

In some aspects, an augmented information retrieval engine 124 may process the prompt 122 and retrieve information from the augmented information repository 116. The augmented information retrieval engine 124 may employ one or more matching algorithms to match the prompt 122 with the augmented information from the augmented information repository 116, potentially utilizing methods such as semantic search techniques to understand the meaning and context of the prompt 122, techniques to rank and prioritize matched content received from the augmented information repository 116, and/or personalization algorithms to tailor results based on user preferences or history. For example, one or more of the datasets 118 and/or 120 including one or more content units 114 may be provided as augmented information. The output of this retrieval process, represented as augmented information 126, may include relevant content from the original information item 104, as well as additional data from datasets 118 and 120. In some examples, the augmented information 126 may comprise various elements such as context from the information item 104, generated question-answer tuples, generated question-context tuples, and/or generated question-context-answer tuples. Accordingly, the augmented information retrieval engine 124 may provide a contextually relevant response to the prompt 122, leveraging both content from the information item 104 and synthetically generated augmentations stored in the augmented information repository 116.

In some aspects, the language model 128 may receive the prompt 122 and the augmented information 126 and generate the final output 130. In some aspects, the incorporation of the augmented information 126 with the prompt 122 may be performed in accordance with a knowledge ingestion strategy to enhance the language model's 128 capabilities by incorporating external information. For example, when using a RAG technique, the language model 128 may dynamically retrieve relevant information (e.g., augmented information 126) to inform the responses of the language model 128. This allows the language model 128 to access information without requiring constant retraining. In the context of the system 100, RAG enables the language model 128 to leverage both the information item 104 and the synthetically generated augmentations (e.g., augmented information 126) to generate a more accurate and contextually relevant final output 130.

In some examples, the system 100 may operate in two phases: pre-query processing phase 132 and query-time processing phase 134. The pre-query processing phase 132 may occur before the receipt of a prompt 122 and may be directed to preparing and augmenting information for retrieval. During this phase, the system 100 may process one or more information items 104 from the information repository 102 to create the augmented information repository 116. This pre-processing may include, but is not limited to: dividing information items into contextual units 108 using the contextual unit allocator 106; generating augmented content (e.g., content units 114) using the language model 110; and creating datasets 118 and 120 within the augmented information repository 116. By performing these operations in advance, the system 100 may generate a knowledgebase (e.g., augmented information repository 116) that can be accessed and utilized during real-time queries.

The query-time processing phase 134, may encompass operations that occur during and/or after the receipt of a prompt 122. The query-time processing phase 134 may utilize the pre-processed information (e.g., augmented information repository 116) to provide relevant responses to user queries, such as prompt 122. The query-time processing phase 134 may include processing of the prompt 122 by the augmented information retrieval engine 124, which may retrieve relevant augmented information 126 from the augmented information repository 116. The language model 128 may then utilize this augmented information 126 along with the original prompt 122 to generate a final output 130 that may be provided to or otherwise displayed to a user. The query-time processing phase 134 allows the system 100 to combine pre-processed knowledge with the specific context of a user's prompt (e.g., prompt 122), enabling the language model 128 to provide more accurate and contextually appropriate responses.

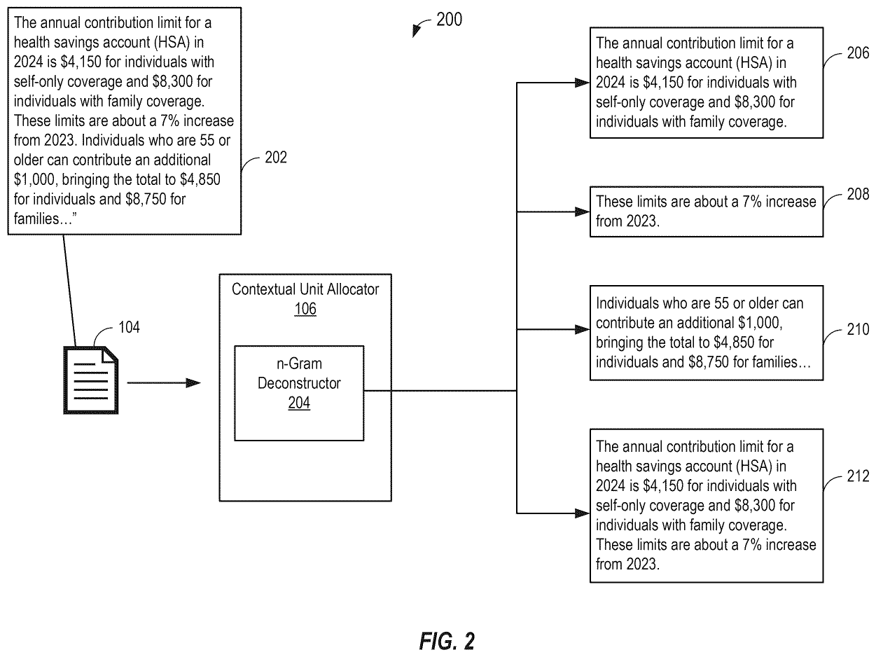

FIG. 2 illustrates an example process 200 for allocating contextual units from an information item, in accordance with aspects of the present disclosure. The process depicted in FIG. 2 may be implemented by the system 100 described in FIG. 1, particularly the contextual unit allocator 106. In some aspects, the example process 200 may be performed as part of the pre-query processing phase 132 to prepare information for subsequent retrieval and augmentation.

In some examples, an information item 104 may be provided as input to the example process 200. The information item 104 may contain textual information related to a specific topic or subject matter. For instance, the information item 104 may be a document 202 describing health savings account (HSA) contribution limits for the year 2024. In some aspects, the information item 104 may be retrieved from the information repository 102 or received from an external source.

The information item 104 may be processed by a contextual unit allocator 106, which may include an n-gram deconstructor 204. In some aspects, the n-gram deconstructor 204 may analyze the structure and content of the information item 104 to divide it into smaller, meaningful units of information. The n-gram deconstructor 204 may employ various techniques to identify appropriate boundaries for contextual units within the information item 104.

In some examples, the n-gram deconstructor 204 may utilize an n-gram approach to generate contextual units. The value of ‘n’ in the n-gram approach may be adjusted based on the desired granularity of the contextual units. For instance, a 1-gram approach may create contextual units consisting of individual sentences, while a 2-gram approach may create units of two consecutive sentences. The n-gram deconstructor 204 may apply multiple n-gram approaches simultaneously to generate a diverse set of contextual units.

In addition to the n-gram approach, the contextual unit allocator 106 may employ other methods to generate contextual units. These methods may include, but are not limited to: paragraph-based segmentation, where each paragraph in the information item 104 is treated as a separate contextual unit; topic-based segmentation using natural language processing techniques to identify distinct topics or themes within the information item 104; semantic similarity-based clustering, which groups semantically related portions of the information item 104 into contextual units; named entity recognition for entity-centric segmentation, focusing on specific entities mentioned in the information item 104; and temporal or chronological segmentation for time-based content, particularly useful for historical or event-based information items.

The contextual unit allocator 106 may generate multiple contextual units from the information item 104. In the example shown in FIG. 2, four contextual units 206, 208, 210, and 212 are depicted. These contextual units represent different portions or aspects of the information contained within the information item 104.

Contextual unit 206 may represent a piece of information extracted from the information item 104. In this example, contextual unit 206 contains information about the annual contribution limit for a health savings account (HSA) in 2024 for individuals with self-only coverage and family coverage. This contextual unit may be generated using a 1-gram or 2-gram approach, capturing a complete thought or statement from the information item 104.

As an example, contextual unit 208 may contain additional information related to the HSA contribution limits. Specifically, the content of contextual unit 208 notes that the limits represent an increase from the previous year. This contextual unit may be generated using a 1-gram approach, capturing a single sentence that provides context to the information in contextual unit 206. The contextual unit allocator 106 may recognize the relationship between these two units and maintain their association for further processing.

In some examples, contextual unit 210 may provide information about an additional contribution allowance for certain individuals. In this case, information in the contextual unit 210 indicates that individuals who are 55 or older can contribute an extra amount to their HSA. This contextual unit may be generated using a 2-gram or 3-gram approach, combining related sentences to capture a complete thought or rule.

In some examples, contextual unit 212 may contain a repetition or rephrasing of information from contextual unit 206. This repetition may be intentional, as it allows the system 100 of FIG. 1 to capture different phrasings or presentations of the same information. Such variations can be useful for generating diverse question-answer tuples or for improving retrieval accuracy under different query formulations.

In some aspects, the contextual unit allocator 106 may assign metadata to each contextual unit. Metadata may include information such as the source location within the information item 104 (FIG. 1), the method used to generate the contextual unit (e.g., 1-gram, 2-gram, paragraph-based), and any identified relationships with other contextual units. This metadata may be used in subsequent processing steps to maintain context and improve the quality of generated content.

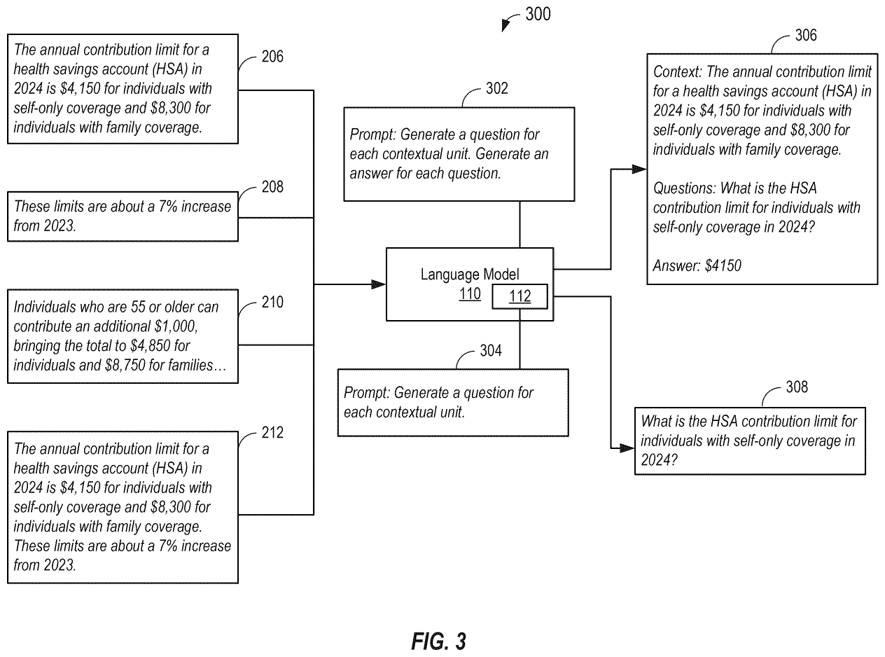

The contextual units generated by the contextual unit allocator 106 may serve as input for further processing steps in the system 100 (FIG. 1). For example, these contextual units may be used by the language model 110 (FIGS. 1 and 3) to generate content units 114 (FIG. 1), which may include question-answer tuples, expanded explanations, or other forms of augmented content. By breaking down the information item 104 (FIG. 1) into these smaller, focused units, the system 100 (FIG. 1) can generate more precise and relevant augmented content, ultimately improving the quality and accuracy of responses to user queries.

FIG. 3 illustrates an example process 300 for generating content units from contextual units using a language model, in accordance with aspects of the present disclosure. The example process 300 depicted in FIG. 3 may be implemented by the system 100 described in FIG. 1, particularly utilizing the language model 110 to generate content units 114 based on contextual units 108. In some aspects, this example process 300 may be performed as part of the pre-query processing phase 132 to prepare augmented information for subsequent retrieval and use.

In some examples, the example process 300 begins with contextual units 206, 208, 210, and 212, which have been previously generated by the contextual unit allocator 106 as described in relation to FIG. 2. These contextual units may be provided as input to the language model 110, which may process them to generate new, augmented content units.

The language model 110, as previously described, may be a large language model trained on text data. In some aspects, the language model 110 may be specifically fine-tuned for tasks related to question generation, paraphrasing, or information augmentation. The language model 110 may employ various architectures, such as transformer-based models, and may be capable of understanding context and generating human-like text based on input prompts.

In some examples, the language model 110 may receive prompts 112 to guide its generation of content units. These prompts may be designed to elicit specific types of information or transformations from the contextual units. In the example shown in FIG. 3, two specific prompts, 302 and 304, are illustrated.

Prompt 302 may instruct the language model 110 to “Generate a question for each contextual unit. Generate an answer for each question.” This prompt directs the language model 110 to create question-answer tuples based on the information contained in each contextual unit. In some aspects, this approach may be useful for creating a diverse set of potential questions that users might ask about the information, along with appropriate answers.

In some examples, the language model 110 may process each contextual unit individually with prompt 302. For instance, when processing contextual unit 206, the language model might generate a question like “What is the annual contribution limit for a health savings account (HSA) in 2024 for individuals with self-only coverage?” and provide the corresponding answer based on the information in the contextual unit.

Prompt 304 may provide a more specific instruction to the language model 110, directing it to “Generate a question for each contextual unit.” This prompt focuses solely on question generation without explicitly requesting answers. In some aspects, this approach may be useful for creating a diverse set of potential queries that could be used for retrieval or for guiding users to relevant information.

In some examples, the language model 110 may apply prompt 304 to each contextual unit, generating questions that capture the key information or concepts present in the unit. For instance, when processing contextual unit 208, the language model might generate a question like “How much have the HSA contribution limits increased from 2023?”

The output of the language model 110, guided by these prompts, may include various content units. In the example shown in FIG. 3, two specific content units, 306 and 308, are illustrated as examples of the types of augmented content that may be generated.

Content unit 306 may represent an example of a question-answer-context tuple generated by the language model 110 in response to prompt 302. The content unit 306 may include a context statement reiterating the key information from contextual unit 206, a question derived from that information, and an answer corresponding to the question. In some aspects, this format may be useful for retrieval-augmented generation tasks, as it provides both the original context and a pre-generated question-answer pair that can be used to enhance the accuracy and relevance of responses to user queries.

In some examples, the context statement in content unit 306 may serve multiple purposes. For example, the context statement may help maintain the connection to the original information source, provide additional context for the question and answer, and may improve the retrieval accuracy by including relevant keywords and phrases from the original contextual unit.

Content unit 308 may represent an example of a question generated by the language model 110 in response to prompt 304. This content unit 308 may include a single question that captures the information from contextual unit 206. In some aspects, this type of content unit may be useful for creating a question bank that can be used for various purposes, such as information retrieval, query expansion, or generating training data for other language models. In some examples, the question in content unit 308 may be designed to be more general or open-ended than the question in content unit 306. This approach may allow for a wider range of potential answers or interpretations, which may be useful in scenarios where the system 100 of FIG. 1 is to handle a variety of user query formulations.

The content units generated by the language model 110, such as 306 and 308, may be stored in the augmented information repository 116 as part of datasets 118 or 120. These augmented content units may then be used to enhance the system's 100 of FIG. 1 ability to provide accurate and relevant responses to user queries.

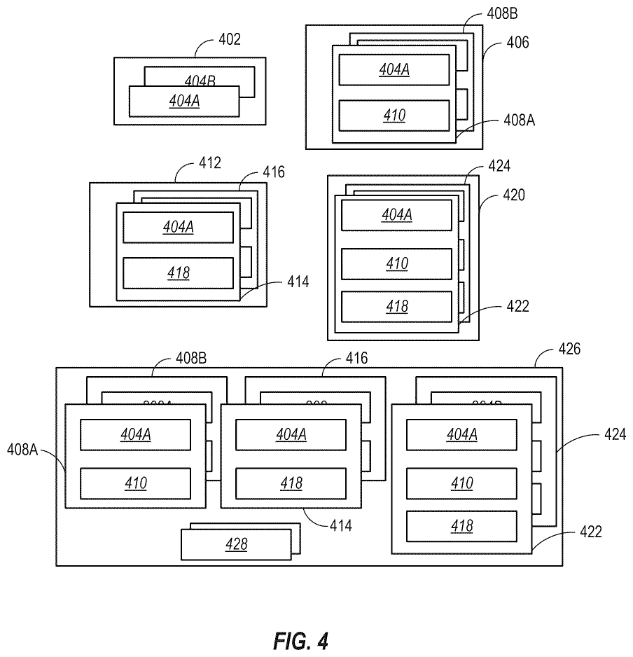

FIG. 4 depicts various configurations for assembling and augmenting datasets derived from a synthetic knowledge ingestion processes, in accordance with aspects of the present disclosure. In some aspects, dataset 402 refers to a dataset comprising content items 404A and 404B. In some examples, dataset 402 may be the same as or similar to dataset 118 (FIG. 1) as previously described. In some examples, content items 404A and 404B may correspond to different types of data generated during a fine-grained synthesis process, based on n-gram contextual units to allow for a balanced incorporation of both detailed and overarching content.

For instance, content items 404A and 404B may represent question-only units derived from the same source material using different n-gram approaches. The question-only units may be generated by querying a large language model (LLM) with a specific set of sentences from the knowledge base, conditioned on the entire knowledge paragraph. As an example, content item 404A may represent a question-only unit generated using a 1-gram approach, while 404B could represent a question-only unit generated using a 2-gram or 3-gram approach. Although two content items 404A and 404B are depicted in FIG. 4, the dataset 402 may include one or more content items, potentially representing a set of n-gram hypothetical questions.

In some aspects, dataset 406 refers to a dataset comprising content items 408A and 408B. In some examples, dataset 406 may be the same as or similar to dataset 118 as previously described. Content items 408A may include a question-context pair comprising a question-only content item 404A as described for dataset 402 and a context item 410 corresponding to the question-only content item 404A. The dataset 402 may represent a variant which includes synthetic hypothetical questions with their corresponding knowledge context. In some examples, content items 408B may include a similar question-context pair derived from the same source material (e.g., information item 104 of FIG. 1) using different n-gram approaches. For a 1-gram approach, this could result in m question-context tuples. Although two content items 408A and 408B are depicted in FIG. 4, the dataset 406 may include one or more content items, representing multiple n-gram approaches.

In some aspects, dataset 412 refers to a dataset resulting from an interleaved generation process. In some aspects, dataset 412 may include content items 414 and 416. In some examples, dataset 412 may be the same as or similar to dataset 118 (FIG. 1) as previously described. The content item 414 may include a question-only content item 404A as previously described. Content item 418 may include a corresponding answer generated simultaneously with the question-only content item 404A through an interleaved generation strategy. An interleaved generation strategy may generate question-answer tuples based on a specific knowledge context. Although only one question-answer pair (e.g., content items 404A and 418) is depicted in FIG. 4, dataset 412 may include one or more such tuples, potentially representing a set of n-gram hypothetical questions and their corresponding answers.

In some aspects, dataset 420 refers to an expanded configuration resulting from an interleaved generation process. The dataset 420 may include multiple content items 422 and 424 that include multiple instances of question-only content items 404A, context item 410, and answer content item 418. In some examples, dataset 420 may be the same as or similar to dataset 118 (FIG. 1) as previously described. As previously described, 404A represents a question-only unit and 418 represents the corresponding answer. In some aspects, context item 410 represents the knowledge context from which the question-answer (QA) tuples are derived. This configuration allows for the representation of question-answer tuples and question-answer-context tuples. The layered structure of dataset 420 allows for the representation of more nuanced relationships between different types of synthetic knowledge representations generated through an interleaved processes. Although dataset 420 depicts content items 422 and 424, dataset 420 may include one or more of each type of content item, potentially representing multiple n-gram approaches.

In some aspects, dataset 426 refers a comprehensive dataset resulting from an assembly augmentation process. The dataset 426 may include the previously described content items 408A, 408B, 414, 416, 422, and 424 and further include knowledge context. In some examples, dataset 426 may be the same as or similar to dataset 118 (FIG. 1) as previously described, but with additional augmentation and assembly. This dataset 426 depicts the combination of multiple layers of data representations, contextual information, and specialized structures. The result of the assembly augmentation process as depicted by dataset 426 may provide an increased repetition of data elements with diversity, combining n-gram syntheses and various pair and tuple types (Question-Context, Question-Answer, Question-Context-Answer) to create a multifaceted knowledge representation. For example, dataset 426 may include, assemblies of question-context tuples, assemblies of question-answer tuples, assemblies of question-context-answer tuples, n-gram contexts 428, and/or combinations of items from different n-gram generations. The comprehensive assembly allows for the representation of complex relationships between different types of synthetic knowledge, which may improve a model's ability to understand and generate responses across a wide range of tasks and domains. Although the dataset 426 is depicted as including a specific number of content items, dataset 426 may include multiple instances of each type of content item, representing various n-gram approaches and combination strategies.

In examples, a fine-grained synthesis process may be used to create a dataset of both detailed and hierarchical content, addressing a challenge of crafting questions that capture knowledge without overlooking an overall context, such as the context of the information item 104. An interleaved generation approach may simultaneously generate question-answer tuples based on specific knowledge contexts, thereby providing contextual alignment and relevance between questions and their corresponding answers. An assembly augmentation approach may be employed to increase repetition with diversity, combining n-gram syntheses and various pair types (question-context, question-answer, question-context-answer) to create a multifaceted knowledge representation. The comprehensive assembly may allow for the representation of complex relationships between different types of synthetic knowledge.

In some aspects, each of the items within the content items depicted in FIG. 4 may be provided from the content units 114 previously described. These content units 114 (FIG. 1) may be generated by the language model 110 (FIG. 1) based on contextual units 108 (FIG. 1) and the information item 104 (FIG. 1). The various configurations depicted in FIG. 4, including question-only units, question-context tuples, question-answer tuples, and question-context-answer tuples, may originate from these content units 114 (FIG. 1).

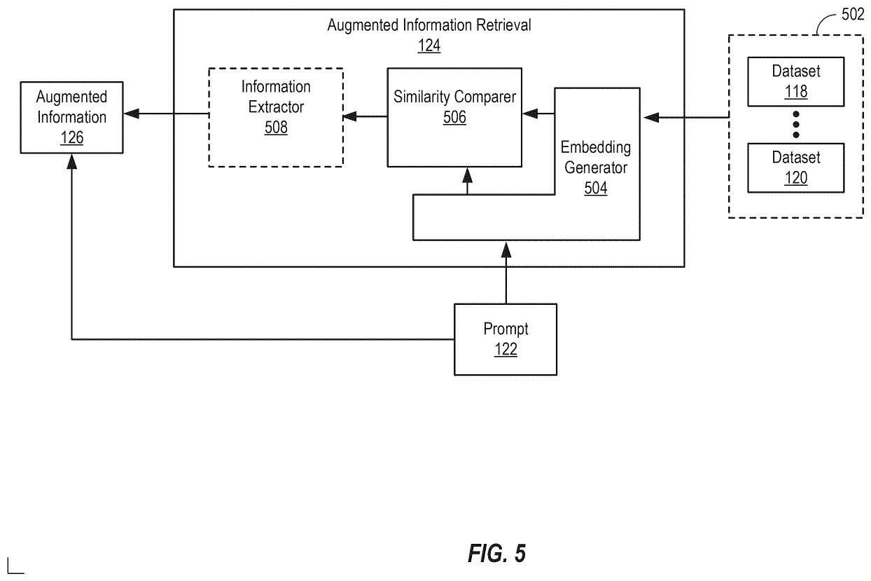

FIG. 5 additional details of an augmented information retrieval engine 124 utilizing synthetic knowledge ingestion techniques, in accordance with aspects of the present disclosure. In examples, a user query (e.g., prompt 122) may be processed and relevant information may be retrieved from augmented datasets, which may enable a language model to provide more accurate and

In some aspects, the prompt 122 represents an input query or instruction provided by a user to initiate the information retrieval process. The prompt 122 may be a natural language question, a keyword search, or a more structured query designed to retrieve specific information from the augmented datasets. In some examples, the prompt 122 may be processed and analyzed to extract key concepts, intent, and context to improve the accuracy and relevance of the retrieved information.

The augmented information retrieval engine 124 may process the prompt 122 and retrieve relevant information from one or more datasets 502. In some aspects, the augmented information retrieval engine 124 may implement techniques to understand the user's query and match it with the most appropriate information available in the augmented datasets. For example, the augmented information retrieval engine 124 may include an embedding generator 504 and a similarity comparer 506. The embedding generator 504 and the similarity comparer 506 may work together to obtain information based on the input prompt.

For example, the embedding generator 504 may transform textual data into numerical representations that can be efficiently processed by machine learning algorithms. In some aspects, the embedding generator 504 may utilize natural language processing techniques to convert the prompt 122 and elements from the datasets 502 into high-dimensional vector representations, also known as embeddings. In some examples, the embedding generator 504 may employ pre-trained language models or custom-trained embedding algorithms to capture the semantic meaning and contextual nuances of the input text from the prompt 122.

In some aspects, the similarity comparer 506 may identify the most relevant information based on the input prompt 122. In some aspects, the similarity comparer 506 may utilize various similarity metrics to measure the closeness or relevance between the embedding of the prompt and the embeddings of the information stored in the datasets. For example, the similarity comparator 506 may employ cosine similarity to measure the cosine of the angle between two vectors in a multi-dimensional space. In some examples, the similarity comparer 506 may calculate the cosine similarity between the prompt embedding and the embeddings of various pieces of information in the datasets, ranking them based on their similarity scores. In some aspects, one or more of cosine similarity, Euclidean distance, Hamming distance, or other similarity measure may be employed.

For example, suppose a prompt 122 is “What is the HSA contribution limit for individuals with self-only coverage in 2024?” In some aspects, the embedding generator 504 may generate an embedding for the prompt 122. The embedding for the prompt 122 may be compared to one or more embeddings of information in the dataset 502. For example, if an information item 104 has been augmented to include a question-context pair that looks like the following:

Question: “What are the HSA contribution limits for 2024?”
Context: “The annual contribution limit for a health savings
account (HSA) in 2024 is $4,150 for individuals with self-only
coverage and $8,300 for individuals with family coverage.
These limits are about a 7% increase from 2023.”

In some examples, the embedding of the above question-context pair may be identified as highly relevant due to the semantic similarity between the prompt 122 and the generated question. In some aspects, a similarity metric, such as a cosine similarity metric, may be employed using the embedding of the prompt 122 and an embedding of the question-context pair. In instances where the prompt 122 and question-context pair is identified (e.g., via ranking similarity metrics) as being most relevant, the information extractor 508 may extract information identified as most pertinent from the question-context pair. For example, the information extractor 508 may extract “The annual contribution limit for a health savings account (HSA) in 2024 is $4,150 for individuals with self-only coverage and $8,300 for individuals with family coverage.” Such information may then be provided to the language model 128 (FIG. 1) as augmented information 126 in addition to the prompt 122 being provided to the language model 128 (FIG. 1). In some examples, the entire

The datasets 502, represented by the dashed box in FIG. 5, may include multiple augmented datasets such as dataset 118 and dataset 120. In some aspects, the dataset 502 may contain various types of synthetic knowledge representations generated through the fine-grained synthesis, interleaved generation, and/or assembly augmentation processes described earlier. In some examples, the datasets 502 may include question-context tuples, question-answer tuples, and question-context-answer tuples, derived from original source materials using different n-gram approaches.

The output of the augmented information retrieval engine 124 may be the augmented information 126, which may represent the retrieved and potentially synthesized information relevant to the user's prompt 122. In some aspects, the augmented information 126 may include not only directly matched content from the datasets but also additional context, related information, or even generated responses that provide a more comprehensive answer to the user's query.

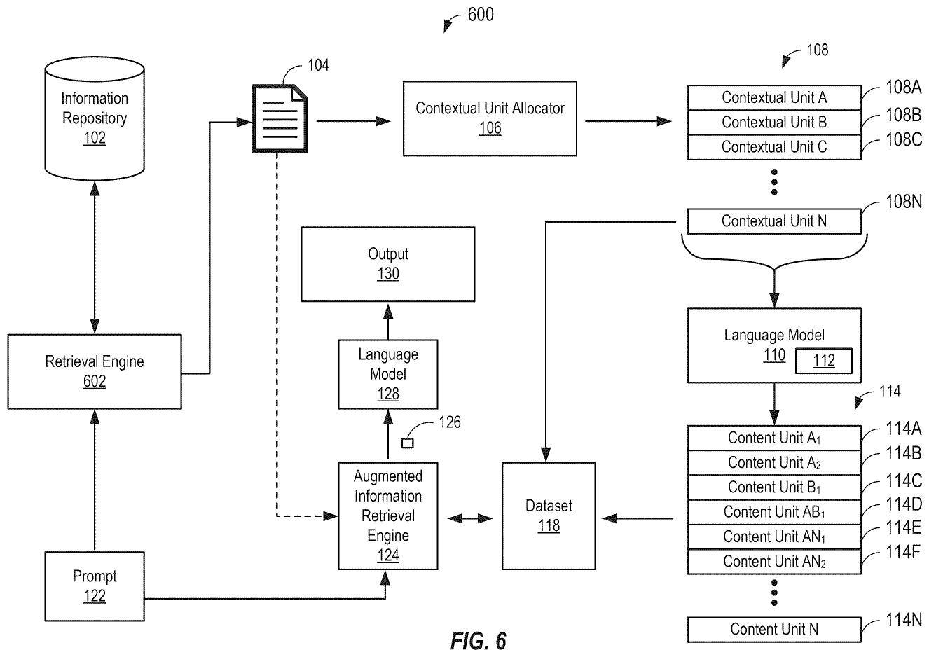

FIG. 6 depicts a system 600 for augmenting an information repository to enhance large language model performance in a real-time, query-driven manner. In some aspects, a prompt may be received at 122, where the prompt 122 may represent a user query or instruction as previously described. The prompt 122 may be processed by a retrieval engine 602, which may query an information repository 102 to identify and retrieve a relevant information item 104. The retrieved information item 104 may then be passed to a contextual unit allocator 106. In some examples, the contextual unit allocator 106 may analyze the structure and content of the information item 104 to divide it into smaller, more focused units of information, referred to as contextual units 108 as previously described with respect to FIG. 1.

Following the generation of contextual units 108, a language model 110 may process the contextual units 108 to create content units 114. As previously described, the content units (114A, 114B, 114C, . . . , 114N) generated by the language model may include various forms of augmented or transformed versions of the original contextual units, such as questions, summaries, or paraphrases. The generated content units 114 may then be organized into a dataset 118. In some examples, this dataset may contain structured representations of the augmented information, such as question-answer tuples, question-context tuples, or other formats that facilitate efficient retrieval and utilization by the system as previously described.

The augmented information retrieval engine 124 may receive the prompt 122 and input from the dataset 118 and match information of the prompt 122 with relevant augmented information from the dataset 118. At least one distinction of the system depicted in FIG. 6 from the system depicted in FIG. 1 is that the system 600 can be performed in real-time and may be query-driven. Different from the system 100 of FIG. 1 that may utilize preprocessed information, system 600 may provide for the dynamic generation and augmentation of information based on the specific context of each prompt 122.

### Example Method for Augmenting an Information Repository

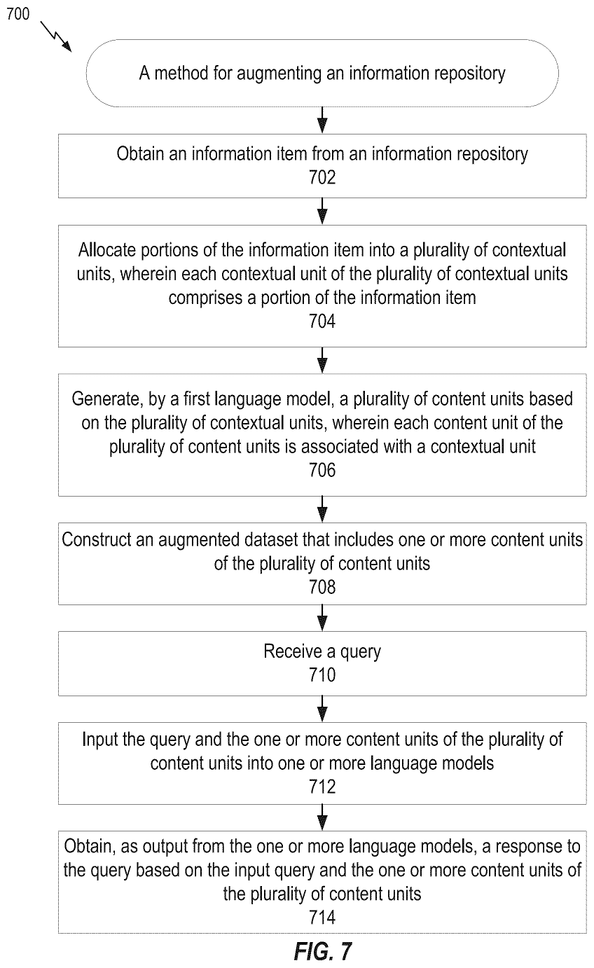

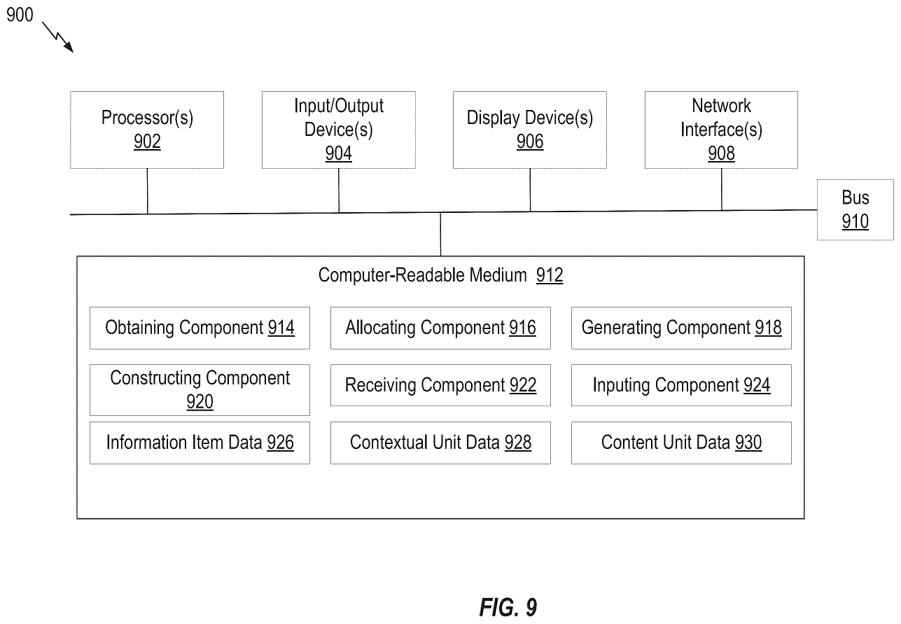

FIG. 7 depicts an example method 700 for augmenting an information repository to enhance large language model performance. In one aspect, method 700 can be implemented by the system 100 of FIG. 1 and/or processing system 900 of FIG. 9.

Method 700 starts at block 702 with obtaining an information item from an information repository. This step may be performed by the system 100 retrieving an information item 104 from the information repository 102 as described in FIG. 1.

Method 700 continues to block 704 with allocating portions of the information item into a plurality of contextual units, wherein each contextual unit of the plurality of contextual units comprises a portion of the information item. This allocation process may be carried out by the contextual unit allocator 106 as illustrated in FIG. 1 and further detailed in FIG. 2.

Method 700 continues to block 704 with generating, by a first language model, a plurality of content units based on the plurality of contextual units, wherein each content unit of the plurality of content units is associated with a contextual unit. This step may be performed by the language model 110 as shown in FIG. 1 and elaborated in FIG. 3.

Method 700 proceeds to block 708 with constructing an augmented dataset that includes one or more content units of the plurality of content units. This construction process may involve creating various configurations of datasets as depicted in FIG. 4.

Method 700 proceeds to block 710 with receiving a query. This query may be similar to the prompt 122 described in FIG. 1 and FIG. 5.

Method 700 proceeds to block 712, with inputting the query and the one or more content units of the plurality of content units into one or more language models. This step may utilize the augmented information retrieval engine 124 as detailed in FIG. 5.

Method 700 may end at block 714, with obtaining, as output from the one or more language models, a response to the query based on the input query and the one or more content units of the plurality of content units. This output generation process may be performed by the language model 128 as described in FIG. 1.

In some aspects of method 700, each content unit of the plurality of content units includes at least one of: a question set comprising a plurality of questions; a question-context set comprising a plurality of question-context tuples, wherein each question-context pair of the plurality of question-context tuples includes a contextual unit and a question; a question-answer set comprising a plurality of question-answer tuples, wherein each question-answer pair of the plurality of question-answer tuples includes a question and an answer associated with the question; or a question-context-answer set comprising a plurality of question-context-answer tuples, wherein each question-context-answer tuple of the plurality of question-context-answer tuples includes a contextual unit, a question, and an answer associated with the question.

In some aspects of method 700, inputting the one or more content units of the plurality of content units into the one or more language models comprises: generating a similarity metric for each content unit of the one or more content units, wherein the similarity metric includes a measure of similarity between a respective content unit of the one or more content units and the received query; and selecting content units based on the similarity metric.

In some aspects of method 700, the similarity metric is a cosine distance.

In some aspects, method 700 further includes obtaining a portion of the selected content units, wherein inputting the one or more content units of the plurality of content units into the one or more language models comprises inputting the portion of the selected content units into the one or more language models.

In some aspects of method 700, the first language model and the second language model are a same language model.

In some aspects of method 700, generating the plurality of content units comprises: for each contextual unit of the plurality of contextual units, providing the contextual unit and the information item to the first language model; and obtaining, from the first language model, one or more questions based on the contextual unit and the information item.

In some aspects of method 700, generating the plurality of content units comprises generating a question and an answer based on the contextual unit and the information item for each contextual unit of the plurality of contextual units.

In some aspects of method 700, allocating portions of the information item into the plurality of contextual units comprises applying an n-gram based contextual unit segmentation procedure to the information item, wherein each contextual unit of the plurality of contextual units comprises a sequence of n consecutive sentences or words from the information item.

In some aspects of method 700, applying the n-gram based contextual unit segmentation procedure comprises dividing the information item into contextual units based on a value of a positive integer n.

In some aspects method 700 further includes generating multiple sets of contextual units by varying the value of n, wherein each set of contextual units corresponds to a different n-gram size.

Note that FIG. 7 is just one example of a method, and other methods including fewer, additional, or alternative operations are possible consistent with this disclosure.

Method 700 provides a technical solution to the problem of enhancing large language model performance with up-to-date and contextually relevant information. By dynamically processing information items into contextual units, generating augmented content, and constructing specialized datasets, method 700 enables real-time integration of external knowledge without modifying the underlying language model. The implementation of method 700 may improve the accuracy and relevance of language model responses while reducing the need for frequent model retraining, thereby optimizing computational resources and system responsiveness.

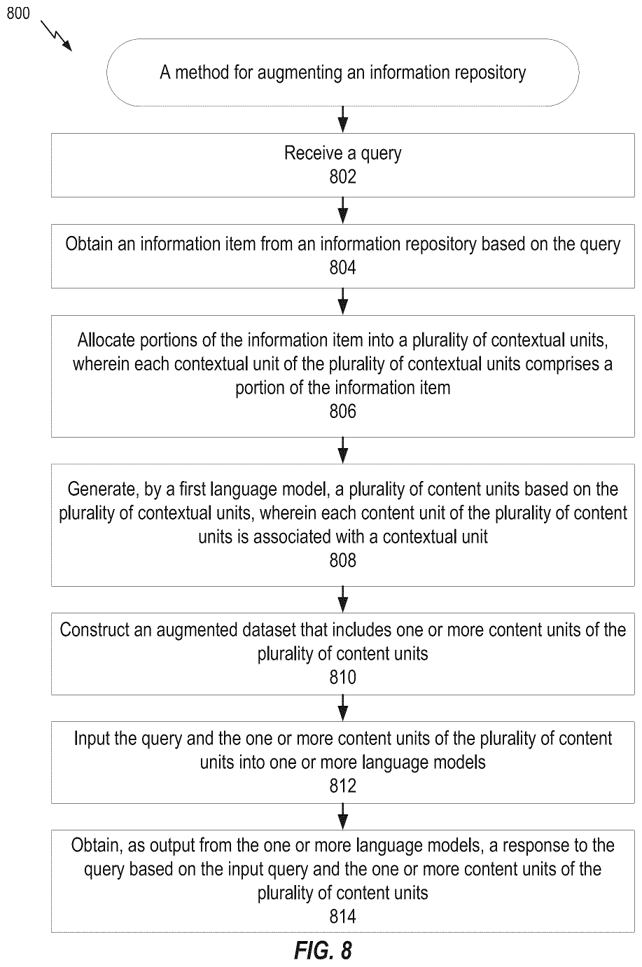

FIG. 8 depicts an example method 800 for augmenting an information repository to enhance large language model performance in a real-time, query-driven manner. In one aspect, method 800 can be implemented by the system 600 of FIG. 6 and/or processing system 900 of FIG. 9.

Method 800 starts at block 802 with receiving a query. This step may be similar to receiving the prompt 122 as described in FIG. 6.

Method 800 continues to block 804 with obtaining an information item from an information repository based on the query. This step may be performed by the retrieval engine 602 querying the information repository 102 to identify and retrieve a relevant information item 104 as illustrated in FIG. 6.

Method 800 proceeds to block 806, with portions of the information item into a plurality of contextual units, wherein each contextual unit of the plurality of contextual units comprises a portion of the information item. This allocation process may be carried out by the contextual unit allocator 106 as shown in FIG. 6 and detailed in FIG. 2.

Method 800 then proceeds to block 808 with generating, by a first language model, a plurality of content units based on the plurality of contextual units, wherein each content unit of the plurality of content units is associated with a contextual unit. This step may be performed by the language model 110 as depicted in FIG. 6 and elaborated in FIG. 3.

Method 800 then proceeds to block 810 with constructing an augmented dataset that includes one or more content units of the plurality of content units. This construction process may involve organizing the generated content units 114 into a dataset 118 as shown in FIG. 6.

Method 800 proceeds to block 812 with inputting the query and the one or more content units of the plurality of content units into one or more language models. This step may utilize the augmented information retrieval engine 124 as illustrated in FIG. 6.

Method 800 may end at block 814 with obtaining, as output from the one or more language models, a response to the query based on the input query and the one or more content units of the plurality of content units. This output generation process may be performed by the language model 128 as described in FIG. 6.

In some aspects of method 800, each content unit of the plurality of content units includes at least one of: a question set comprising a plurality of questions; a question-context set comprising a plurality of question-context tuples, wherein each question-context pair of the plurality of question-context tuples includes a contextual unit and a question; a question-answer set comprising a plurality of question-answer tuples, wherein each question-answer pair of the plurality of question-answer tuples includes a question and an answer associated with the question; or a question-context-answer set comprising a plurality of question-context-answer tuples, wherein each question-context-answer tuple of the plurality of question-context-answer tuples includes a contextual unit, a question, and an answer associated with the question.

In some aspects of method 800, inputting the one or more content units of the plurality of content units into the one or more language models comprises: generating a similarity metric for each content unit of the one or more content units, wherein the similarity metric includes a measure of similarity between a respective content unit of the one or more content units and the received query; and selecting content units based on the similarity metric.

In some aspects of method 800, the similarity metric is a cosine distance.

In some aspects, method 800 further includes obtaining a portion of the selected content units, wherein inputting the one or more content units of the plurality of content units into the one or more language models comprises inputting the portion of the selected content units into the one or more language models.

In some aspects of method 800, the first language model and the second language model are a same language model.

In some aspects of method 800, generating the plurality of content units comprises: for each contextual unit of the plurality of contextual units, providing the contextual unit and the information item to the first language model; and obtaining, from the first language model, one or more questions based on the contextual unit and the information item.

In some aspects of method 800, generating the plurality of content units comprises generating a question and an answer based on the contextual unit and the information item for each contextual unit of the plurality of contextual units.

In some aspects of method 800, allocating portions of the information item into the plurality of contextual units comprises applying an n-gram based contextual unit segmentation procedure to the information item, wherein each contextual unit of the plurality of contextual units comprises a sequence of n consecutive sentences or words from the information item.

In some aspects of method 800, applying the n-gram based contextual unit segmentation procedure comprises dividing the information item into contextual units based on a value of a positive integer n.

In some aspects method 800 further includes generating multiple sets of contextual units by varying the value of n, wherein each set of contextual units corresponds to a different n-gram size.

Note that FIG. 8 is just one example of a method, and other methods including fewer, additional, or alternative operations are possible consistent with this disclosure.

In some aspects, method 800 provides a real-time, query-driven approach to augmenting information repositories for enhancing language model performance. By dynamically processing relevant information items based on the incoming query, method 800 may enable on-the-fly generation of contextually appropriate augmented datasets. Aspects of method 800 may allow for immediate augmentations to user queries without relying on pre-processed information, thereby improving the accuracy and relevance of responses while maintaining system flexibility and responsiveness to diverse and evolving user needs.

### Example Processing System for Augmenting an Information Repository

FIG. 9 depicts an example processing system 900 configured to perform various aspects described herein, including, for example, method 700 as described above with respect to FIG. 7 and method 800 as described above with respect to FIG. 8.

Processing system 900 is generally be an example of an electronic device configured to execute computer-executable instructions, such as those derived from compiled computer code, including without limitation personal computers, tablet computers, servers, smart phones, smart devices, wearable devices, augmented and/or virtual reality devices, and others.

In the depicted example, processing system 900 includes one or more processors 902, one or more input/output device(s) 904, one or more display device(s) 906, one or more network interface(s) 908 through which processing system 900 is connected to one or more networks (e.g., a local network, an intranet, the Internet, or any other group of processing systems communicatively connected to each other), and computer-readable medium 912. In the depicted example, the aforementioned components are coupled by a bus 910, which may generally be configured for data exchange amongst the components. Bus 910 may be representative of multiple buses, while only one is depicted for simplicity.

Processor(s) 902 are generally configured to retrieve and execute instructions stored in one or more memories, including local memories like computer-readable medium 912, as well as remote memories and data stores. Similarly, processor(s) 902 are configured to store application data residing in local memories like the computer-readable medium 912, as well as remote memories and data stores. More generally, bus 910 is configured to transmit programming instructions and application data among the processor(s) 902, display device(s) 906, network interface(s) 908, and/or computer-readable medium 912. In certain embodiments, processor(s) 902 are representative of a one or more central processing units (CPUs), graphics processing unit (GPUs), tensor processing unit (TPUs), accelerators, and other processing devices.

Input/output device(s) 904 may include any device, mechanism, system, interactive display, and/or various other hardware and software components for communicating information between processing system 900 and a user of processing system 900. For example, input/output device(s) 904 may include input hardware, such as a keyboard, touch screen, button, microphone, speaker, and/or other device for receiving inputs from the user and sending outputs to the user.

Display device(s) 906 may generally include any sort of device configured to display data, information, graphics, user interface elements, and the like to a user. For example, display device(s) 906 may include internal and external displays such as an internal display of a tablet computer or an external display for a server computer or a projector. Display device(s) 906 may further include displays for devices, such as augmented, virtual, and/or extended reality devices. In various embodiments, display device(s) 906 may be configured to display a graphical user interface.

Network interface(s) 908 provide processing system 900 with access to external networks and thereby to external processing systems. Network interface(s) 908 can generally be any hardware and/or software capable of transmitting and/or receiving data via a wired or wireless network connection. Accordingly, network interface(s) 908 can include a communication transceiver for sending and/or receiving any wired and/or wireless communication.

Computer-readable medium 912 may be a volatile memory, such as a random access memory (RAM), or a nonvolatile memory, such as nonvolatile random access memory (NVRAM), or the like. In this example, computer-readable medium 912 includes obtaining component 914, allocating component 916, generating component 918, constructing component 920, receiving component 922, and inputting component 924. The computer-readable medium 912 also stores information item data 926, contextual unit data 928, and content unit data 930, which are used and manipulated by the various components to perform the method steps described in FIGS. 7 and 8.

In certain embodiments, obtaining component 914 is configured to obtain an information item from an information repository, as described in block 702 of FIG. 7 and block 802 of FIG. 8. Allocating component 916 is configured to allocate portions of the information item into a plurality of contextual units, as described in block 704 of FIG. 7 and block 804 of FIG. 8. Generating component 918 is configured to generate, by a first language model, a plurality of content units based on the plurality of contextual units, wherein each content unit of the plurality of content units is associated with a contextual unit, as described in block 706 of FIG. 7 and block 806 of FIG. 8. Constructing component 920 is configured to construct an augmented dataset that includes one or more content units of the plurality of content units, as described in block 708 of FIG. 7 and block 808 of FIG. 8. Receiving component 922 is configured to receive a query, as described in block 710 of FIG. 7 and block 810 of FIG. 8. Inputting component 924 is configured to input the query and the one or more content units of the plurality of content units into one or more language models, as described in block 712 of FIG. 7 and block 812 of FIG. 8. Obtaining component These components work together to implement the methods described in FIGS. 7 and 8, utilizing the stored data (926, 928, 930) and interacting with the hardware components (902, 904, 906, 908) via bus 910 to augment the information repository and enhance large language model performance. In certain embodiments, obtaining component 914 is configured to obtain, as output from the one or more language models, a response to the query based on the input query and the one or more content units of the plurality of content units, as described in block 714 of FIG. 7 and block 814 of FIG. 8.

Note that FIG. 9 is just one example of a processing system consistent with aspects described herein, and other processing systems having additional, alternative, or fewer components are possible consistent with this disclosure.

### EXAMPLE CLAUSES

Implementation examples are described in the following numbered clauses:

Clause 1: A method for augmenting an information repository for information retrieval by a large language model, the method comprising: obtaining an information item from an information repository; allocating portions of the information item into a plurality of contextual units, wherein each contextual unit of the plurality of contextual units comprises a portion of the information item; generating, by a first language model, a plurality of content units based on the plurality of contextual units, wherein each content unit of the plurality of content units is associated with a contextual unit; constructing an augmented dataset that includes one or more content units of the plurality of content units; receiving a query; inputting the query and the one or more content units of the plurality of content units into one or more language models; and obtaining, as output from the one or more language models, a response to the query based on the input query and the one or more content units of the plurality of content units.

Clause 2: The method of Clause 1, wherein each content unit of the plurality of content units includes at least one of: a question set comprising a plurality of questions; a question-context set comprising a plurality of question-context tuples, wherein each question-context pair of the plurality of question-context tuples includes a contextual unit and a question; a question-answer set comprising a plurality of question-answer tuples, wherein each question-answer pair of the plurality of question-answer tuples includes a question and an answer associated with the question; or a question-context-answer set comprising a plurality of question-context-answer tuples, wherein each question-context-answer tuple of the plurality of question-context-answer tuples includes a contextual unit, a question, and an answer associated with the question.

Clause 3: The method of any of Clauses 1-3, wherein inputting the one or more content units of the plurality of content units into the one or more language models comprises: generating a similarity metric for each content unit of the one or more content units, wherein the similarity metric includes a measure of similarity between a respective content unit of the one or more content units and the received query; and selecting content units based on the similarity metric.

Clause 4: The method of Clause 3, wherein the similarity metric is a cosine distance.

Clause 5: The method of Clause 3, further comprising obtaining a portion of the selected content units, wherein inputting the one or more content units of the plurality of content units into the one or more language models comprises inputting the portion of the selected content units into the one or more language models.

Clause 6: The method of any of Clauses 1-5, wherein the first language model and the second language model are a same language model.

Clause 7: The method of any of Clauses 1-6, wherein generating the plurality of content units comprises: for each contextual unit of the plurality of contextual units, providing the contextual unit and the information item to the first language model; and obtaining, from the first language model, one or more questions based on the contextual unit and the information item.

Clause 8: The method of any of Clauses 1-7, wherein generating the plurality of content units comprises generating a question and an answer based on the contextual unit and the information item for each contextual unit of the plurality of contextual units.

Clause 9: The method of any of Clauses 1-8, wherein allocating portions of the information item into the plurality of contextual units comprises applying an n-gram based contextual unit segmentation procedure to the information item, wherein each contextual unit of the plurality of contextual units comprises a sequence of n consecutive sentences or words from the information item.

Clause 10: The method of Clause 9, wherein applying the n-gram based contextual unit segmentation procedure comprises dividing the information item into contextual units based on a value of a positive integer n.

Clause 11: The method of Clause 10, further comprising: generating multiple sets of contextual units by varying the value of n, wherein each set of contextual units corresponds to a different n-gram size.

Clause 12: A method for augmenting an information repository for information retrieval by a large language model, the method comprising: receiving a query; obtaining an information item from an information repository based on the query; allocating portions of the information item into a plurality of contextual units, wherein each contextual unit of the plurality of contextual units comprises a portion of the information item; generating, by a first language model, a plurality of content units based on the plurality of contextual units, wherein each content unit of the plurality of content units is associated with a contextual unit; constructing an augmented dataset that includes one or more content units of the plurality of content units; inputting the query and the one or more content units of the plurality of content units into one or more language models; and obtaining, as output from the one or more language models, a response to the query based on the input query and the one or more content units of the plurality of content units.

Clause 13: A processing system, comprising: a memory comprising computer-executable instructions; and a processor configured to execute the computer-executable instructions and cause the processing system to perform a method in accordance with any one of Clauses 1-12.

Clause 14: A processing system, comprising means for performing a method in accordance with any one of Clauses 1-12.

Clause 15: A non-transitory computer-readable medium storing program code for causing a processing system to perform the steps of any one of Clauses 1-12.

Clause 16: A computer program product embodied on a computer-readable storage medium comprising code for performing a method in accordance with any one of Clauses 1-12.

### ADDITIONAL CONSIDERATIONS

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for augmenting an information repository for information retrieval by a large language model, the method comprising:
obtaining an information item from an information repository;
allocating portions of the information item into a plurality of contextual units, wherein each contextual unit of the plurality of contextual units comprises a portion of the information item;
generating, by a first language model, a plurality of content units based on the plurality of contextual units, wherein each content unit of the plurality of content units is associated with a contextual unit;
constructing an augmented dataset that includes one or more content units of the plurality of content units;
receiving a query;
inputting the query and the one or more content units of the plurality of content units into one or more language models; and
obtaining, as output from the one or more language models, a response to the query based on the input query and the one or more content units of the plurality of content units.

2. The method of claim 1, wherein each content unit of the plurality of content units includes at least one of:
a question set comprising a plurality of questions;
a question-context set comprising a plurality of question-context tuples, wherein each question-context pair of the plurality of question-context tuples includes a contextual unit and a question;
a question-answer set comprising a plurality of question-answer tuples, wherein each question-answer pair of the plurality of question-answer tuples includes a question and an answer associated with the question; or
a question-context-answer set comprising a plurality of question-context-answer tuples, wherein each question-context-answer tuple of the plurality of question-context-answer tuples includes a contextual unit, a question, and an answer associated with the question.

3. The method of claim 1, wherein inputting the one or more content units of the plurality of content units into the one or more language models comprises:
generating a similarity metric for each content unit of the one or more content units, wherein the similarity metric includes a measure of similarity between a respective content unit of the one or more content units and the received query; and
selecting content units based on the similarity metric.

4. The method of claim 3, wherein the similarity metric is a cosine distance.

5. The method of claim 3, further comprising obtaining a portion of the selected content units, wherein inputting the one or more content units of the plurality of content units into the one or more language models comprises inputting the portion of the selected content units into the one or more language models.

6. The method of claim 1, wherein the first language model and the one or more language models are a same language model.

7. The method of claim 1, wherein generating the plurality of content units comprises:
for each contextual unit of the plurality of contextual units, providing the contextual unit and the information item to the first language model; and
obtaining, from the first language model, one or more questions based on the contextual unit and the information item.

8. The method of claim 1, wherein generating the plurality of content units comprises generating a question and an answer based on the contextual unit and the information item for each contextual unit of the plurality of contextual units.

9. The method of claim 1, wherein allocating portions of the information item into the plurality of contextual units comprises applying an n-gram based contextual unit segmentation procedure to the information item, wherein each contextual unit of the plurality of contextual units comprises a sequence of n consecutive sentences or words from the information item.

10. The method of claim 9, wherein applying the n-gram based contextual unit segmentation procedure comprises dividing the information item into contextual units based on a value of a positive integer n.

11. The method of claim 10, further comprising generating multiple sets of contextual units by varying the value of n, wherein each set of contextual units corresponds to a different n-gram size.

12. A processing system, comprising: a memory comprising computer-executable instructions; and a processor configured to execute the computer-executable instructions and cause the processing system to:
obtain an information item from an information repository;
allocate portions of the information item into a plurality of contextual units, wherein each contextual unit of the plurality of contextual units comprises a portion of the information item;
generate, by a first language model, a plurality of content units based on the plurality of contextual units, wherein each content unit of the plurality of content units is associated with a contextual unit;
construct an augmented dataset that includes one or more content units of the plurality of content units;
receive a query;
input the query and the one or more content units of the plurality of content units into one or more language models; and
obtain, as output from the one or more language models, a response to the query based on the input query and the one or more content units of the plurality of content units.

13. The processing system of claim 12, wherein each content unit of the plurality of content units includes at least one of:
a question set comprising a plurality of questions;
a question-context set comprising a plurality of question-context tuples, wherein each question-context pair of the plurality of question-context tuples includes a contextual unit and a question;
a question-answer set comprising a plurality of question-answer tuples, wherein each question-answer pair of the plurality of question-answer tuples includes a question and an answer associated with the question; or
a question-context-answer set comprising a plurality of question-context-answer tuples, wherein each question-context-answer tuple of the plurality of question-context-answer tuples includes a contextual unit, a question, and an answer associated with the question.

14. The processing system of claim 12, wherein to input the one or more content units of the plurality of content units into the one or more language models comprises to:
generate a similarity metric for each content unit of the one or more content units, wherein the similarity metric includes a measure of similarity between a respective content unit of the one or more content units and the received query; and
select content units based on the similarity metric.

15. The processing system of claim 14, wherein the similarity metric is a cosine distance.

16. The processing system of claim 12, wherein to generate the plurality of content units comprises to:
for each contextual unit of the plurality of contextual units, provide the contextual unit and the information item to the first language model; and
obtain, from the first language model, one or more questions based on the contextual unit and the information item.

17. A method for augmenting an information repository for information retrieval by a large language model, the method comprising:
receiving a query;
obtaining an information item from an information repository based on the query;
allocating portions of the information item into a plurality of contextual units, wherein each contextual unit of the plurality of contextual units comprises a portion of the information item;
generating, by a first language model, a plurality of content units based on the plurality of contextual units, wherein each content unit of the plurality of content units is associated with a contextual unit;
constructing an augmented dataset that includes one or more content units of the plurality of content units;
inputting the query and the one or more content units of the plurality of content units into one or more language models; and
obtaining, as output from the one or more language models, a response to the query based on the input query and the one or more content units of the plurality of content units.

18. The method of claim 17, wherein each content unit of the plurality of content units includes at least one of:
a question set comprising a plurality of questions;
a question-context set comprising a plurality of question-context tuples, wherein each question-context pair of the plurality of question-context tuples includes a contextual unit and a question;
a question-answer set comprising a plurality of question-answer tuples, wherein each question-answer pair of the plurality of question-answer tuples includes a question and an answer associated with the question; or
a question-context-answer set comprising a plurality of question-context-answer tuples, wherein each question-context-answer tuple of the plurality of question-context-answer tuples includes a contextual unit, a question, and an answer associated with the question.

19. The method of claim 17, wherein inputting the one or more content units of the plurality of content units into the one or more language models comprises:
generating a similarity metric for each content unit of the one or more content units, wherein the similarity metric includes a measure of similarity between a respective content unit of the one or more content units and the received query; and
selecting content units based on the similarity metric.

20. The method of claim 17, wherein allocating portions of the information item into the plurality of contextual units comprises applying an n-gram based contextual unit segmentation procedure to the information item, wherein each contextual unit of the plurality of contextual units comprises a sequence of n consecutive sentences or words from the information item.
